(19) United States
(12) Patent Application Publication
(10) Pub. No.: US 2025/0308108 A1
(43) Pub. Date: Oct. 2, 2025

(54) HUMAN POSE RENDERING

(71) Applicants: Denso International America, Inc., Southfield, MI (US); Carnegie Mellon University, Pittsburgh, PA (US); Denso Corporation, Kariya-City (JP)

(72) Inventors: Shawn Hunt, Bethel Park, PA (US); Kris Makoto Kitani, Pittsburgh, PA (US); Jinhyung Park, Pittsburgh, PA (US); Shun Iwase, Pittsburgh, PA (US); Rawal Khirodkar, Pittsburgh, PA (US); Mana Masuda, Pittsburgh, PA (US)

(21) Appl. No.: 18/616,942

(22) Filed: Mar. 26, 2024

(51) Int. Cl. G06T 11/60; G06T 7/70; G06V 10/44; G06V 10/771

(52) U.S. Cl. CPC G06T 11/60; G06T 7/70; G06V 10/44; G06V 10/771

(57) ABSTRACT

Systems, methods, and other embodiments described herein relate to improving view synthesis of humans using a generalizable approach without test-time optimization. In one embodiment, a method includes acquiring target information and sensor data of a surrounding environment that includes a person. The target information defines a target space that includes a target pose and a target camera view. The method includes extracting appearance features of the person from the sensor data. The method includes mapping the appearance features into the target space, including aggregating the appearance features into an aggregated feature map. The method includes rendering the target camera view of the person in the target pose according to the aggregated feature map. The method includes providing the target camera view.

### TECHNICAL FIELD

The subject matter described herein relates in general to systems and methods for improving view synthesis of humans and, more particularly, to using a generalizable approach for view synthesis that avoids test-time optimization.

### BACKGROUND

Various devices that provide information about a surrounding environment often use sensors that facilitate perceiving obstacles and additional aspects of the surrounding environment. As one example, a device uses information from the sensors to develop awareness of the surrounding environment in order to identify and avoid hazards when navigating the environment and/or to predict the motion of agents (e.g., people) within the environment. In particular, the device uses the perceived information to determine a structure of the environment and characteristics of the agents so that the device may distinguish between different regions and identify potential hazards or other aspects that improve awareness. The ability to perceive accurate information about the environment and derive useful information therefrom can be a complex task.

For example, within an environment that includes people, accurately perceiving and predicting aspects of the people can be difficult. This can be due to the variance in the population of people, including differences in size, proportions, gait, and so on. In particular, when predicting a different view, models are generally constrained to only people for which the model has previously been trained. Thus, the model must have a dataset about a particular person and be trained to provide views of that particular person. However, this is generally infeasible when considering the population as a whole or the computational requirements to train the model on-the-fly. Moreover, approaches that do not provide for test-time optimization generally suffer from reasoning about multi-view consistency between limited source views of a highly dynamic, deformable subject. As such, the ability to predict other views of a person in support of systems perceiving and planning within an environment are constrained under current approaches.

### SUMMARY

Example systems and methods associated with improving view synthesis of humans using a generalizable approach are disclosed. As previously noted, predicting views of a person that are unseen by a camera can be a complex task. For example, accurately predicting views for a unique individual that the system has previously not seen can be difficult due to nuances between different people. As mentioned, currently, systems may require test-time optimization in order to perform view synthesis, which is computationally intensive and may not be feasible due to a lack of data for separate individuals.

Therefore, in one embodiment, a disclosed approach involves a unique approach that implements explicit body priors, multi-view geometry, and learnable rendering to facilitate generalizable neural human rendering (GNH). This approach effectively generalizes to unseen subjects in novel poses, thereby overcoming the noted difficulties. For example, in one implementation, an inventive system implements a multi-step processing pipeline to reconstruct a subject in a target pose when given source images and poses of a subject. In general, the approach involves first extracting three-dimensional features from source images. The system maps the features to a target space using three-dimensional body priors, where the target space is defined by a request of the target pose. The system then aggregates the mapped source features and renders an image from the aggregated features. In this way, the system is able to synthesize unique views of a human without performing test-time optimization.

In one embodiment, a pose system is disclosed. The pose system includes one or more processors and a memory that is communicably coupled to the one or more processors. The memory stores instructions that, when executed by the one or more processors, cause the one or more processors to acquire target information and sensor data of a surrounding environment that includes a person. The target information defines a target space that includes a target pose and a target camera view. The instructions include instructions to extract appearance features of the person from the sensor data. The instructions include instructions to map the appearance features into the target space, including aggregating the appearance features into an aggregated feature map. The instructions include instructions to render the target camera view of the person in the target pose according to the aggregated feature map. The instructions include instructions to provide the target camera view.

In one embodiment, a non-transitory computer-readable medium is disclosed. The computer-readable medium stores instructions that, when executed by one or more processors, cause the one or more processors to perform the disclosed functions. The instructions include instructions to acquire target information and sensor data of a surrounding environment that includes a person. The target information defines a target space that includes a target pose and a target camera view. The instructions include instructions to extract appearance features of the person from the sensor data. The instructions include instructions to map the appearance features into the target space, including aggregating the appearance features into an aggregated feature map. The instructions include instructions to render the target camera view of the person in the target pose according to the aggregated feature map. The instructions include instructions to provide the target camera view.

In one embodiment, a method is disclosed. The method includes acquiring target information and sensor data of a surrounding environment that includes a person. The target information defining a target space that includes a target pose and a target camera view. The method includes extracting appearance features of the person from the sensor data. The method includes mapping the appearance features into the target space, including aggregating the appearance features into an aggregated feature map. The method includes rendering the target camera view of the person in the target pose according to the aggregated feature map. The method includes providing the target camera view.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle in which example systems and methods disclosed herein may operate.

FIG. 2 illustrates one embodiment of a pose system that is associated with improving view synthesis of humans using a generalizable approach without test-time optimization.

FIG. 3 shows an illustrative example of synthesizing a novel view of a person.

FIG. 4 illustrates a detailed example of source feature extraction, feature mapping, and multi-view aggregation.

FIG. 5 is a diagram illustrating one embodiment of feature extraction.

FIG. 6 is a flowchart showing a method associated with improving view synthesis of humans using a generalizable approach without test-time optimization.

### DETAILED DESCRIPTION

Systems, methods, and other embodiments associated with improving view synthesis of humans using a generalizable approach are disclosed. As previously noted, predicting views of a person that are unseen by a camera can be a complex task. For example, accurately predicting views for a unique individual that the system has previously not seen can be difficult due to nuances between different people. As mentioned, currently, systems may require test-time optimization in order to perform view synthesis, which is computationally intensive and may not be feasible due to a lack of data for separate individuals.

Therefore, in one embodiment, a disclosed approach involves a unique approach that implements explicit body priors, multi-view geometry, and learnable rendering to facilitate generalizable neural human rendering (GNH). This approach effectively generalizes to unseen subjects in novel poses, thereby overcoming the noted difficulties. For example, in one implementation, an inventive system implements a multi-step processing pipeline to reconstruct a subject in a target pose when given source images and poses of a subject. In general, the approach involves first extracting three-dimensional features from source images. The system maps the features to a target space using three-dimensional body priors, where the target space is defined by a request of the target pose. The system then aggregates the mapped source features and renders an image from the aggregated features. In this way, the system is able to synthesize unique views of a human without performing test-time optimization.

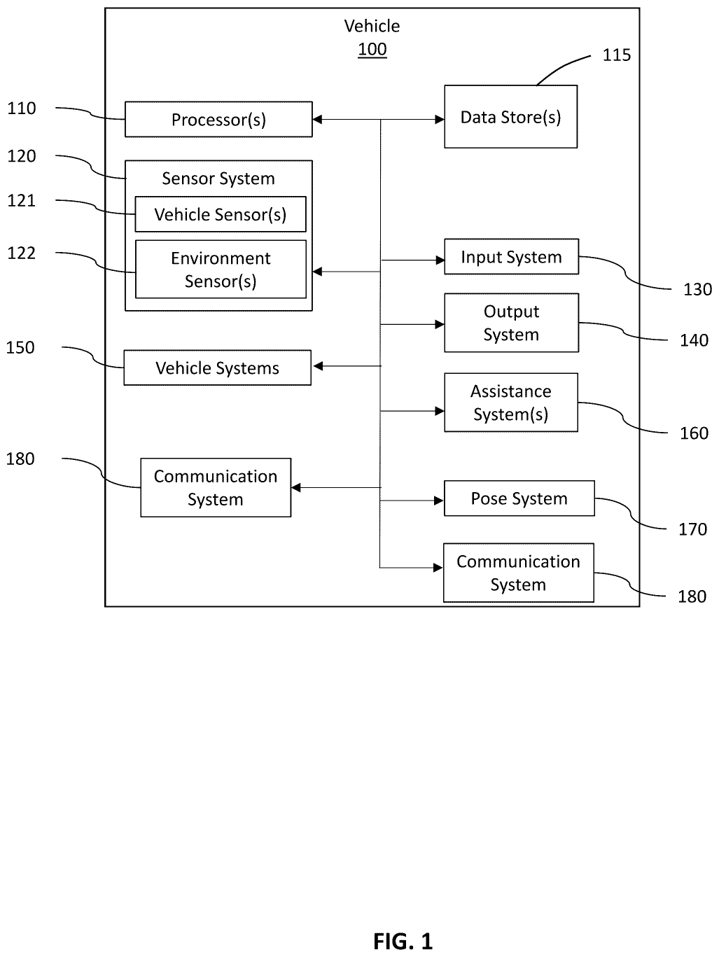

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, instead of a vehicle, the disclosed systems and methods may be implemented in a device, such as infrastructure (e.g., a roadside unit (RSU)), an aerial device (e.g., a drone), a mobile phone, and so on. Accordingly, the vehicle 100 is shown and described as including the pose system 170 for purposes of the present discussion; however, in further aspects, the pose system 170 may be implemented within other devices. Moreover, while the vehicle 100 or another individual device is generally described as performing the noted functions, it should be appreciated that one or more of the functions may be implemented in a cloud-based environment, where, for example, the pose system 170 is implemented as a service that accepts and fulfills requests from various entities, such as an RSU that communicates sensor data and a request.

The vehicle 100 also includes various elements. It will be understood that, in various embodiments, the vehicle 100 may not have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

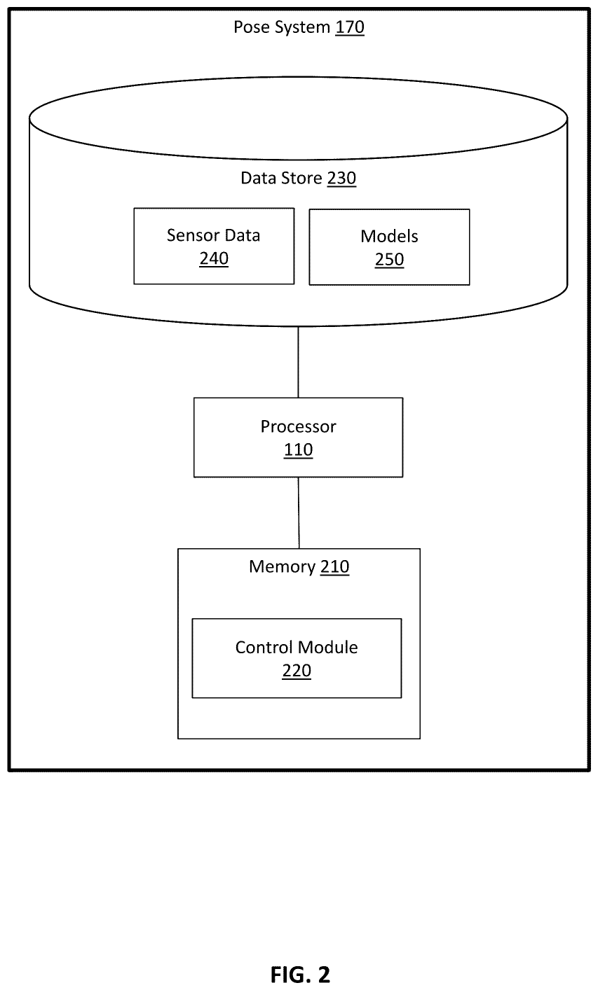

Some of the possible elements of the vehicle 100 are shown in FIG. 1 and will be described along with subsequent figures. A description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding, analogous, or similar elements. Furthermore, it should be understood that the embodiments described herein may be practiced using various combinations of the described elements.

In any case, the vehicle 100 includes a pose system 170 that functions to improve the synthesis of unique views of a human without test-time optimization (i.e., training on the specific person). Moreover, while depicted as a standalone component, in one or more embodiments, the pose system 170 may be integrated with the assistance system 160 or another similar system of the vehicle 100 or another device within which the pose system 170 is implemented to facilitate functions of the other systems/modules. The noted functions and methods will become more apparent with a further discussion of the figures.

As a further aspect, the vehicle 100 also includes a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via short-range communications, such as a Bluetooth, Wi-Fi, or another suitable protocol for communicating between the vehicle 100 and other nearby devices (e.g., other vehicles, infrastructure elements, etc.). Moreover, the communication system 180, in one arrangement, further communicates according to a long-range protocol, such as the global system for mobile communication (GSM), Enhanced Data Rates for GSM Evolution (EDGE), or another communication technology that provides for the vehicle 100 communicating with a cloud-based resource. In either case, the system 170 can leverage various wireless communications technologies to facilitate communications with nearby vehicles (e.g., vehicle-to-vehicle (V2V)), nearby infrastructure elements (e.g., vehicle-to-infrastructure (V2I), vehicle-to-anything (V2X), etc.), and so on. For example, in one or more arrangements, the pose system 170 may acquire sensor data (e.g., images and depth information) from nearby or remote entities.

With reference to FIG. 2, one embodiment of the pose system 170 is further illustrated. As shown, the pose system 170 includes a processor 110. Accordingly, the processor 110 may be a part of the pose system 170, or the pose system 170 may access the processor 110 through a data bus or another communication pathway. In one or more embodiments, the processor 110 is an application-specific integrated circuit that is configured to implement functions associated with a control module 220. More generally, in one or more aspects, the processor 110 is an electronic processor, such as a microprocessor, that is capable of performing various functions as described herein when executing encoded functions associated with the pose system 170.

In one embodiment, the pose system 170 includes a memory 210 that stores the control module 220. The memory 210 is a random-access memory (RAM), read-only memory (ROM), a hard disk drive, a flash memory, or other suitable memory for storing the module 220. The module 220 is, for example, computer-readable instructions that, when executed by the processor 110, cause the processor 110 to perform the various functions disclosed herein. While, in one or more embodiments, the module 220 is instructions embodied in the memory 210, in further aspects, the module 220 includes hardware, such as processing components (e.g., controllers), circuits, etc. for independently performing one or more of the noted functions.

Furthermore, in one embodiment, the pose system 170 includes a data store 230. The data store 230 is, in one arrangement, an electronically-based data structure for storing information. For example, in one approach, the data store 230 is a database that is stored in the memory 210 or another suitable medium, and that is configured with routines that can be executed by the processor 110 for analyzing stored data, providing stored data, organizing stored data, and so on. In any case, in one embodiment, the data store 230 stores data used by the module 220 in executing various functions. In one embodiment, the data store 230 includes sensor data 240, and models 250 along with, for example, other information that is used by the control module 220.

Accordingly, the control module 220 generally includes instructions that function to control the processor 110 to acquire data inputs from one or more sensors of the vehicle 100 and/or of other devices that form the sensor data 240. In general, the sensor data 240 includes information that embodies observations of the surrounding environment of the vehicle 100 or another device in which the pose system 170 or a client thereof is situated. The observations of the surrounding environment, in various embodiments, can include surrounding scenes that may be a roadway/driving environment or another area that includes at least one person. Broadly, the sensor data 240 includes images in the form of RGB images from a monocular camera. Of course, in further arrangements, the sensor data 240 may include other modalities of information, such as point clouds from a LiDAR, depth maps from stereo cameras or derived from monocular images, radar returns, and so on.

While the control module 220 is discussed as controlling the various sensors to provide the sensor data 240, in one or more embodiments, the control module 220 can employ other techniques to acquire the sensor data 240 that are either active or passive. For example, the control module 220 may passively sniff the sensor data 240 from a stream of electronic information provided by the various sensors to further components within the vehicle 100, acquire the sensor data 240 or at least a portion thereof via a wireless communication link (e.g., vehicle to everything (V2X), Wi-Fi, DSRC, etc.), and so on. That is, the sensor data 240 may include information acquired via the communication system 180, such as data from other vehicles and/or infrastructure devices. The pose system 170 may acquire images and/or other data from other vehicles, mobile devices, roadside units, etc. Moreover, the control module 220 can undertake various approaches to fuse data from multiple sensors/sources when providing the sensor data 240. Thus, the sensor data 240, in one embodiment, may represent a combination of perceptions acquired from multiple sensors.

In any case, the control module 220 acquires the sensor data 240 that includes at least images from, for example, the camera 126 or another imaging device. The images are generally RGB images. As described herein, the images are, for example, images from the camera 126 or another imaging device that encompasses a field-of-view (FOV) about the vehicle 100 of at least a portion of the surrounding environment. That is, an image is, in one approach, generally limited to a subregion of the surrounding environment. As such, the image may be of a forward-facing (i.e., the direction of travel) 60, 90, 120-degree FOV, a rear/side facing FOV, or some other subregion as defined by the imaging characteristics (e.g., lens distortion, FOV, etc.) of the camera 126. In various aspects, the camera 126 is a pinhole camera, a fisheye camera, a catadioptric camera, or another form of camera that acquires images.

An individual image itself includes visual data of the FOV that is encoded according to an imaging standard (e.g., codec) associated with the camera 126 or another imaging device that is the source. In general, characteristics of a source camera (e.g., camera 126) define a format of the image. Thus, while the particular characteristics can vary according to different implementations, in general, the image has a defined resolution (i.e., height and width in pixels) and format.

Additionally, as previously noted, the sensor data 240 can further includes depth data about a scene depicted by the associated images. The depth data indicates distances from a depth/range sensor that acquired the depth data to features in the surrounding environment. The depth data, in one or more approaches, is of a particular density that is associated with the modality of acquisition. That is, the particular sensor or approach to acquiring the depth data may vary and thereby have varying properties. For example, different LiDAR sensors generally have different numbers of scan lines, which influences the density of depth information within a resulting point cloud. Moreover, other modalities, such as stereo cameras and using a monocular depth estimation network, generally provide dense point clouds that provide pixel-wise depth information. Accordingly, the form of the sensor data 240 can vary depending on the implementation but includes at least RGB-based images.

Continuing with the description of elements stored by the pose system 170, the data store 230 includes models 250. The models 250 include multiple separate models used by the control module 220 in performing the disclosed approach. For example, the models 250 include, in at least one approach, a transformer model, a fine model, a coarse model, a refine model. The various models may take different forms depending on the implementation. In general, the models 250 are machine-learning models that are trained on the specific tasks according to, for example, supervised learning. The models may be transformer-based models, convolutional-based models, or another form of deep neural network (DNN) or a combination thereof. Of course, while multiple separate models are described, in further approaches, the pose system 170 may implement additional models in place of other defined processes or may combine one or more models into an integrated network with shared components (e.g., a shared backbone).

Accordingly, with further reference to FIG. 2, the control module 220 includes instructions that, when executed by the processor 110, cause the processor to acquire target information and sensor data. The target information may be in the form of a request to the pose system 170 for a specific view of a person depicted in the sensor data 240. For example, consider an instance in which the vehicle 100 or an RSU perceives a person in the surrounding environment. One or more systems therein, may generate a request for a different view of the scene including the person, in order to monitor the scene, plan a path, or perform another function. Accordingly, the requesting system generates a request that includes the target information while the control module 220 otherwise acquires the sensor data 240, including at least images of the person. The target information specifies a target pose and a target camera view. The target pose is a pose (i.e., a particular posture including a requested articulation of limbs, the head, etc.) of the person while the target camera view is an orientation of the camera with a particular field-of-view of the scene that is different from the images of the sensor data 240.

The control module 220 then extracts appearance features from the sensor data 240 using the models 250 and then maps the appearance features into a target space associated with the target camera view, thereby aggregating the appearance features from the sensor data 240 together. From the aggregated appearance features, the control module 220 is able to render the target camera view of the person in the target pose and provide the target camera view in response to the request.

As further explanation of the process for rendering the target camera view from the sensor data 240 and the request and without test-time optimization, consider the following discussion. The process assumes that the sensor data 240 includes at least a set of N source images/views of the subject person {Iₛ∈ [symbol] ^{H×W×3}, Pₛ∈ [symbol] ^{3×4}, θₛ∈ [symbol] ^{24×3+10}}ₛ₌₁^{N}, where Iₛ represents the source image, Pₛ, represents the camera extrinsics, and θₛ represents the skinned multi-person linear model (SMPL) body pose and shape parameters. Accordingly, given the source images from the sensor data 240, the control module 220 renders the subject person from a queried target camera view Pₜ and in a specified pose θₜ.

Moreover, under the constraint of no test-time optimization, achieving high-fidelity novel views and pose renderings of the subject is challenging. That is, difficulties arise from reasoning about multi-view consistency between limited source views/images of a highly dynamic, deformable subject. The pose system 170 alleviates these difficulties using data-driven priors from training subjects while focusing on generalizable concepts readily transferrable to novel subjects involves balancing various considerations. The pose system 170 addresses this system within a generalizable neural human renderer (GNH) that addresses the difficulties through a multi-stage process. As a pre-processing aspect, the control module 220 standardizes the scale of subjects in the source images from the sensor data 240. In one approach, the control module 220 crops the images according to a projected two-dimensional skeleton and resizes the image to a defined dimension (e.g., 256×256 pixels).

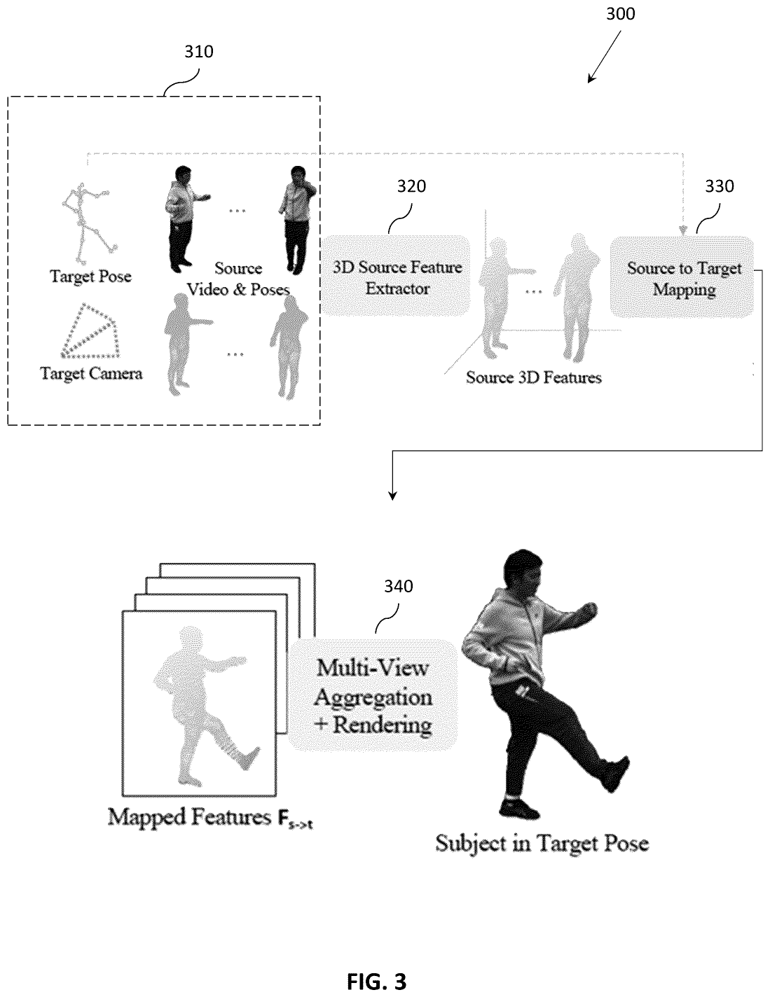

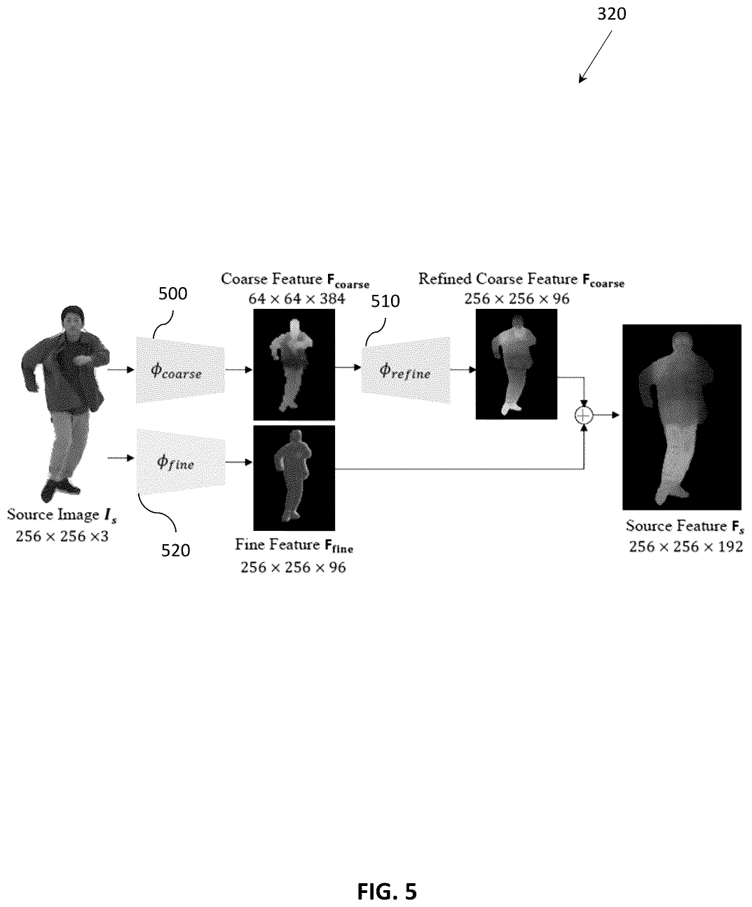

With reference to FIGS. 3-5, an illustrative example 300 of the disclosed process is provided. For example, in FIG. 3, block 310 illustrates the original request that includes the target pose and the target pose along with the sensor data 240, which is illustrated as the source video and poses. Accordingly, after acquiring the initial inputs, the control module 220 proceeds with extracting the appearance features, as shown with block 320 in FIGS. 3-5. In particular, the control module 220 transforms the images into a three-dimensional representation using the topology of the human body and camera projection parameters. For example, the control module 220 first extracts two-dimensional features from each source image/view at both a coarse level and a fine level, as shown in FIG. 5. As shown in FIG. 5, a transformer-based model 500, denoted as ϕ_{coarse}. The model 500 generates a feature map having dimensions 64×64×384 pixels. To better align the features to novel view synthesis, the control module 220 refines and up-samples the features using a model 510, denoted as ϕ_{refine}, which includes convolutional and self-attention layers. The control module 220 further implements a parallel fine-grained extraction using model 520, denoted as ϕ_{fine}, to extract fine features using convolutional layers with a single down-sampling step, in one arrangement. Maintaining a high-resolution feature map preservers high-fidelity details for novel view synthesis. The control module 220 generates per-source view features Fₛ using a channel-wise concatenation of the refined coarse features F_{course} and the fine features F_{fine}.

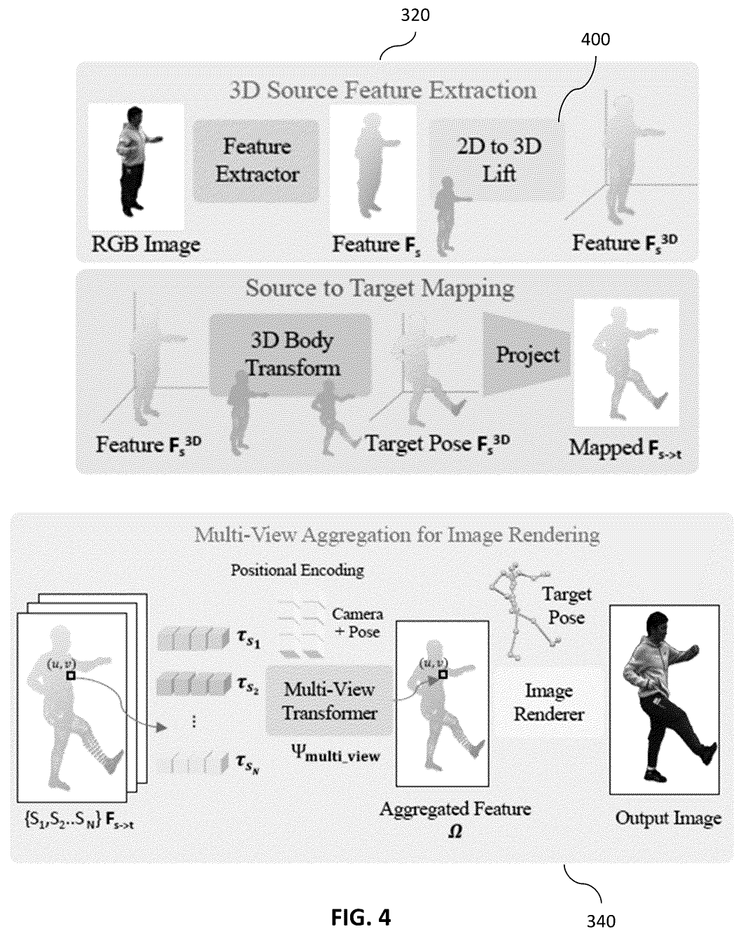

Next, as shown in FIG. 4 at 400, the control module 220 lifts the two-dimensional representation into a three-dimensional representation. The application of the three-dimensional human body prior, as defined by the SMPL parametric model, seamlessly transfers source view features into the target pose. By constraining the source view to the target view feature transfer with the explicit three-dimensional prior, the control module 220 makes the view synthesis of the deformable dynamic objects without test-time optimization feasible. In particular, the control module 220 extracts a three-dimensional mesh [symbol] ₛ from the source pose parameters θₛ, which includes mesh vertices {vₛⁱ}ᵢ₌₁⁶⁸⁹⁰. The control module 220 projects the individual mesh vertices onto the image plane using a projection function Πs of the source camera that acquired the images sensor data 240. The projection, Πₛ(vₛⁱ), allows the control module 220 to extract a 192-dimensional latent feature Fₛ^{3D}(vₛⁱ) from the source feature Fₛ∈ [symbol] ^{256×256×192}. Thus, each 3D source vertex vₛⁱ is associated with a feature as follows in equation 1.

$${F}_{s}^{3 D} ( {v}_{s}^{i} ) = {F}_{s} ( {\prod }_{s} ( {v}_{s}^{i} ) ) \qquad ( 1 )$$

The set of mesh vertices and the associated features are the 3D source features used by the control module 220 for GNH. The control module 220 computes the 3D source features once for each separate image in the sensor data 240. These may then be cached for subsequent use. After generating the appearance features (i.e., the source view features), the control module 220 transforms the source features into the target space, as shown with 330 in FIGS. 3 and 4. The control module 220 transforms the source mesh vertices to the target space (i.e., the target camera view) using the target pose θₜ. Each target mesh vertex vₜⁱ carries a latent feature derived from the separate source view images, as represented by Fₛ^{3D}. The control module 220 independently populates the two-dimensional target view feature map F_{s→t} for each source view. For each pixel in the target image, the control module 220 projects a ray in three dimensions using a projection function Πₜ of the target camera view. The latent feature of the first intersecting vertex vₜⁱ is then assigned by the control module 220 to the intersecting pixel location, as shown in equation 2.

$${F}_{s \to t} ( {\prod }_{t} ( {v}_{t}^{i} ) ) = {F}_{s}^{3 D} ( {v}_{t}^{i} ) \qquad ( 2 )$$

The resulting output of the control module 220 is an appearance feature map for each of the source view images. Thereafter, the control module 220 aggregates the information from the feature maps in the context of the target camera view and the target pose as shown at block 340 of FIGS. 3 and 4. The control module 220 aggregates the source to target mapped features Fₛ_{ᵢ}_{→t} from all of the source images sᵢ∈{s₁ . . . s_{N}} into a single feature map using a transformer encoder Ψ_{multi-view}. The transformer encoder operates on the individual pixels independently. The transformer encoder highlights features from source images relevant to the target camera view and target pose and attenuates features from distance source views. For each pixel (u, v) in the target image, the transformer encoder Ψ_{multi-view} accepts N tokens as input with one token from each source view. Each token corresponds to the latent features Fₛ_{ᵢ}_{→t}(u, v) at that specific location (u, v). This is represented by equations 3 and 4.

$${τ}_{{s}_{i}} = {F}_{{s}_{i} \to t} ( u , v ) \qquad ( 3 )$$

$${Ω}_{u , v} = {Ψ}_{multi - view} ( {τ}_{{s}_{1}} , {τ}_{{s}_{2}} , … , {τ}_{{s}_{N}} ) \qquad ( 4 )$$

where τₛ_{ᵢ} represents the i^{th} input token to Ψ_{multi-view}, representing the feature mapped from source sᵢ to target t's pixel location (u, v). Ω_{u,v} denotes the aggregated multi-view feature at each pixel. Additionally, the transformer encoder Ψ_{multi-view} incorporates the extrinsic parameters of the source camera and the target view camera along with the target pose as part of the positional encoding. This information provides the transformer encoder Ψ_{multi-view} with more information that it can leverage to focus on relevant source views.

The transformer encoder Ψ_{multi-view} outputs a single feature map Ω for the target camera view after adaptively aggregating features from each source view image. To synthesize the image as output, the control module processes the feature map using an image rendering network. For example, the image rendering network may be a deep residual U-Net architecture, denoted as [symbol] . For more structural guidance, the control module 220 conditions the image generation process on the target pose θₜ, which is provided as an additional input to the rendering network [symbol] . In one approach, each target human bone in θₜ is projected onto its own channel, resulting in a 2D spatial representation of θₜ with dimensions 256×256×23. The control module 220 then concatenates the multi-view aggregated feature and target pose along the channel dimension and inputs the result into the rendering network [symbol] to yield the final target-rendered image Îₜ.

$${Ω}^{′} = Ω ⊕ {I}_{θ} \qquad ( 5 )$$

$${\hat{I}}_{t} = ℛ ( {Ω}^{′} ) \qquad ( 6 )$$

Moreover, as noted previously, the models 250 include various models used by the control module 220 in performing the described process. For example, the models 250 include the refinement model ϕ_{refine}, the transformer encoder Ψ_{multi-view}, the fine feature extractor ϕ_{fine}, the image render [symbol] , and so on. In general, the control module 220 performs supervised training to train the models 250 with ground-truth RGB images. The control module 220 may implement a loss function that includes a weighted combination of L1 and L2 norm losses in addition to a perceptual loss using a pre-trained CGG network.

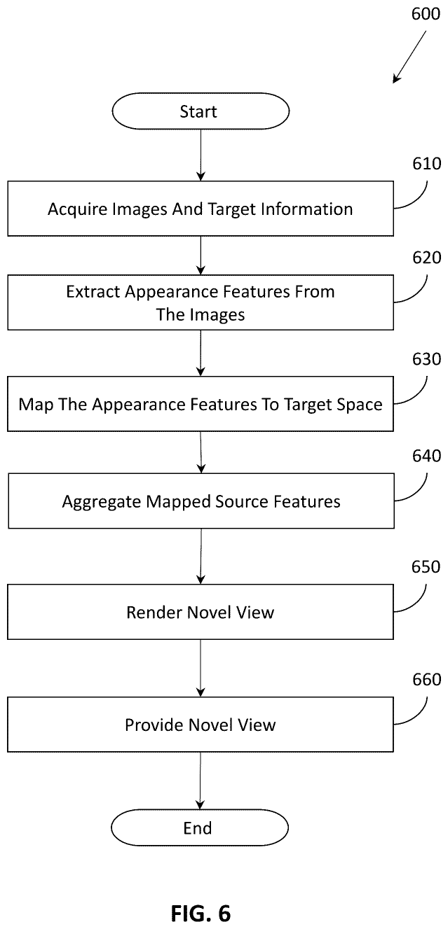

Additional aspects of improving view synthesis of humans using a generalizable approach will be discussed in relation to FIG. 6. FIG. 6 illustrates a method 600 associated with improving the synthesis of unique views of a human without test-time optimization. Method 600 will be discussed from the perspective of the pose system 170 of FIGS. 1-2. While method 600 is discussed in combination with the pose system 170, it should be appreciated that the method 600 is not limited to being implemented within the pose system 170 but is instead one example of a system that may implement the method 600.

At 610, the control module 220 acquires the sensor data 240 and target information. In one embodiment, acquiring the sensor data 240 includes controlling one or more sensors of the vehicle 100 to generate observations about the surrounding environment of the vehicle 100. Alternatively, as noted previously, the system 170 may be implemented within an infrastructure device that is statically mounted in the environment. As such, the control module 220 may acquire the sensor data 240 from integrated sensors, such as a camera, a LiDAR, etc. In still further approaches, the module 220 acquires at least a portion of the sensor data 240 from other devices in the environment via wireless communications.

The control module 220, in one or more implementations, iteratively acquires the sensor data 240 from one or more sensors of the sensor system 120. The sensor data 240 includes observations of a surrounding environment of the vehicle 100 or another device (e.g., a vehicle, an RSU, etc.). As noted previously, the sensor data 240 includes at least RGB monocular images and may further include depth data from a LiDAR or another depth sensor.

In any case, the pose system 170 generally acquires the images as input along with the target information. It should be noted that while the pose system 170 is primarily described as acquiring the image data via integrated sensors, the system 170 can acquire the images from separate cameras. Whichever sources the system 170 uses to acquire the sensor data 240, the sensor data 240 is generally of the same scene and may be from different perspectives and depicts the same person that is the subject of the target information. The target information defines information about how the person is to be rendered in the generated view. Thus, the target information generally defines a target space that includes a target pose of the person and a target camera view. The target pose is a position of the person in relation to the articulation of their limbs, such as their legs, arms, head, and so on. The target camera view is an orientation of the camera depicting the synthesized view of the person. For example, the target camera view may define a rotation, elevation, angle, distance, etc. in relation to a current position of a camera. As previously described, the target information may be generated according to a request from a device that is, for example, monitoring a scene, planning a path through the scene, and so on, and may be generated in order to simulate the person in the environment.

At 620, the control module 220 extracts appearance features of the person from the sensor data 240. Extracting the appearance features may involve multiple steps. For example, the control module 220 applies multiple different models, as previously illustrated in FIG. 5, to extract various granularities of features. In one approach, the control module 220 applies a fine model to the images to generate fine features that include a fine granularity of detail while also applying a coarse model to generate features at a coarse granularity. The fine granularity and the coarse granularity represent different levels of detail in the features with the fine features being, for example, at least twice as granular. In any case, the control module 220 refines the coarse feature using a refine model into refined features and then concatenates/combines the refined features with the fine features to generate the appearance features. As previously noted, the fine model, which generates the fine features, and the coarse model, which generates the coarse features, are encoders, while the refine model is, in one arrangement, a transformer-based model. In addition to extracting the appearance features from the sensor data 240, the control module 220 may further lift the appearance features from a two-dimensional representation to a three-dimensional representation in order to provide the appearance features in a form that can be easily translated to other views.

At 630, the control module 220 maps the appearance features into the target space. In at least one approach, the control module 220 maps the appearance features for each separate image by, for example, transforming the source mesh vertices of the appearance features to the target space (i.e., the target camera view) using the target pose. The control module 220 populates a two-dimensional target feature map for pixels of the target camera view using the appearance features and according to a transformation therebetween.

At 640, the control module 220 aggregates the appearance features into an aggregated feature map. For example, the control module 220, after having mapped the appearance features, is left with a plurality of appearance features in the target space. Some of the mapped features may align with the same pixels. Thus, the control module 220 aggregates the appearance features into the aggregated feature map by, in at least one approach, applying a multi-view transform (e.g., transformer encoder Ψ_{multi-view}) to the two-dimensional target feature map to generate the aggregated feature map.

At 650, the control module 220 renders an image of the target camera view of the person in the target pose according to the aggregated feature map. In one arrangement, the control module 220 renders the target camera view by applying an image rendering network that is conditioned on the target pose to the aggregated feature map. In this way, the pose system 170 is able to generate the view of the person, which is otherwise unavailable, without prior knowledge or training of the person and in a view/pose that is novel.

At 660, the control module 220 provides the target camera view. The control module 220 provides the target camera view, in one or more arrangements, by communicating the target camera view (i.e., the synthesized view of the person) to a path planner of the vehicle 100, by simulating the target camera view according to a request to monitor the person (i.e., generating a simulated scene using the target camera view of the person), and so on. Thus, the vehicle 100 may use the target camera view in planning maneuvers of the vehicle 100 and/or determining the presence of hazards/obstacles, which may influence how the vehicle 100 is controlled by a person or the assistance system 160. In the context of monitoring, the synthesized view may be used within an intersection monitoring system that may be supported by one or more RSUs to reconstruct a view from a different viewpoint than provided by the camera(s) of the RSU. In this way, the pose system 170 is able to improve operation of the vehicle 100 and/or the monitoring system of the RSU by providing additional awareness about the scene.

With reference again to FIG. 1, it should be appreciated that the pose system 170 from FIG. 1 can be configured in various arrangements with separate integrated circuits and/or electronic chips. In such embodiments, the control module 220 is embodied as a separate integrated circuit. The circuits are connected via connection paths to provide for communicating signals between the separate circuits. Of course, while separate integrated circuits are discussed, in various embodiments, the circuits may be integrated into a common integrated circuit and/or integrated circuit board. Additionally, the integrated circuits may be combined into fewer integrated circuits or divided into more integrated circuits. In further embodiments, portions of the functionality associated with the module 220 may be embodied as firmware executable by a processor and stored in a non-transitory memory. In still further embodiments, the module 220 is integrated as hardware components of the processor 110.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

FIG. 1 will now be discussed in full detail as an example environment within which the system and methods disclosed herein may operate. As an additional note, it should be appreciated that, as described previously, the pose system 170 may be implemented within a vehicle or may also be implemented within static infrastructure or as a cloud-based resource. Accordingly, the example of FIG. 1 is illustrative of one approach. In some instances, the vehicle 100 is configured to switch selectively between an autonomous mode, one or more semi-autonomous operational modes, and/or a manual mode. Such switching can be implemented in a suitable manner. “Manual mode” means that all of or a majority of the navigation and/or maneuvering of the vehicle is performed according to inputs received from a user (e.g., human driver).

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is fully automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the pose system 170 to ensure the vehicle 100 remains within defined state constraints.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 (e.g., data store 230) for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data. The map data can include maps of one or more geographic areas. In some instances, the map data can include information (e.g., metadata, labels, etc.) on roads, traffic control devices, road markings, structures, features, and/or landmarks in the one or more geographic areas. In some instances, the map data can include aerial/satellite views. In some instances, the map data can include ground views of an area, including 360-degree ground views. The map data can include measurements, dimensions, distances, and/or information for one or more items included in the map data and/or relative to other items included in the map data. The map data can include a digital map with information about road geometry. The map data can further include feature-based map data such as information about relative locations of buildings, curbs, poles, etc. In one or more arrangements, the map data can include one or more terrain maps. In one or more arrangements, the map data can include one or more static obstacle maps. The static obstacle map(s) can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level.

The one or more data stores 115 can include sensor data (e.g., sensor data 240). In this context, “sensor data” means any information from the sensors that the vehicle 100 is equipped with, including the capabilities and other information about such sensors.

As noted above, the vehicle 100 can include the sensor system 120. The sensor system 120 can include one or more sensors. “Sensor” means any device, component, and/or system that can detect, perceive, and/or sense something. The one or more sensors can be configured to operate in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself or interior compartments of the vehicle 100. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system, and/or other suitable sensors. The vehicle sensor(s) 121 can be configured to detect and/or sense one or more characteristics of the vehicle 100. In one or more arrangements, the vehicle sensor(s) 121 can include a speedometer to determine a current speed of the vehicle 100. Moreover, the vehicle sensor system 121 can include sensors throughout a passenger compartment, such as pressure/weight sensors in seats, seatbelt sensors, camera(s), and so on.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect and/or sense obstacles in at least a portion of the external environment of the vehicle 100 and/or information/data about such obstacles. Such obstacles may be stationary objects and/or dynamic objects. The one or more environment sensors 122 can be configured to detect, and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The vehicle 100 can include an input system 130. An “input system” includes, without limitation, devices, components, systems, elements or arrangements or groups thereof that enable information/data to be entered into a machine. The input system 130 can receive an input from a vehicle passenger (e.g., an operator or a passenger). The vehicle 100 can include an output system 140. An “output system” includes any device, component, or arrangement or groups thereof that enable information/data to be presented to a vehicle passenger (e.g., a person, a vehicle passenger, etc.).

The vehicle 100 can include one or more vehicle systems 150. Various examples of the one or more vehicle systems 150 are shown in FIG. 1, however, the vehicle 100 can include a different combination of systems than illustrated in the provided example. In one example, the vehicle 100 can include a propulsion system, a braking system, a steering system, throttle system, a transmission system, a signaling system, a navigation system, and so on. The noted systems can separately or in combination include one or more devices, components, and/or a combination thereof.

By way of example, the navigation system can include one or more devices, applications, and/or combinations thereof configured to determine the geographic location of the vehicle 100 and/or to determine a travel route for the vehicle 100. The navigation system can include one or more mapping applications to determine a travel route for the vehicle 100. The navigation system can include a global positioning system, a local positioning system or a geolocation system.

The processor(s) 110, the pose system 170, and/or the assistance system 160 can be operatively connected to communicate with the various vehicle systems 150 and/or individual components thereof. For example, returning to FIG. 1, the processor(s) 110 and/or the assistance system 160 can be in communication to send and/or receive information from the various vehicle systems 150 to control the movement, speed, maneuvering, heading, direction, etc. of the vehicle 100. The processor(s) 110, the pose system 170, and/or the assistance system 160 may control some or all of these vehicle systems 150 and, thus, may be partially or fully autonomous.

The processor(s) 110, the pose system 170, and/or the assistance system 160 can be operatively connected to communicate with the various vehicle systems 150 and/or individual components thereof. For example, returning to FIG. 1, the processor(s) 110, the pose system 170, and/or the assistance system 160 can be in communication to send and/or receive information from the various vehicle systems 150 to control the movement, speed, maneuvering, heading, direction, etc. of the vehicle 100. The processor(s) 110, the pose system 170, and/or the assistance system 160 may control some or all of these vehicle systems 150.

The processor(s) 110, the pose system 170, and/or the assistance system 160 may be operable to control the navigation and/or maneuvering of the vehicle 100 by controlling one or more of the vehicle systems 150 and/or components thereof. For instance, when operating in an autonomous mode, the processor(s) 110, the pose system 170, and/or the assistance system 160 can control the direction and/or speed of the vehicle 100. The processor(s) 110, the pose system 170, and/or the assistance system 160 can cause the vehicle 100 to accelerate (e.g., by increasing the supply of energy provided to the engine), decelerate (e.g., by decreasing the supply of energy to the engine and/or by applying brakes) and/or change direction (e.g., by turning the front two wheels).

Moreover, the pose system 170 and/or the assistance system 160 can function to perform various driving-related tasks. The vehicle 100 can include one or more actuators. The actuators can be any element or combination of elements operable to modify, adjust and/or alter one or more of the vehicle systems or components thereof to responsive to receiving signals or other inputs from the processor(s) 110 and/or the assistance system 160. Any suitable actuator can be used. For instance, the one or more actuators can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more modules that form the assistance system 160. The assistance system 160 can be configured to receive data from the sensor system 120 and/or any other type of system capable of capturing information relating to the vehicle 100 and/or the external environment of the vehicle 100. In one or more arrangements, the assistance system 160 can use such data to generate one or more driving scene models. The assistance system 160 can determine the position and velocity of the vehicle 100. The assistance system 160 can determine the location of obstacles, or other environmental features, including traffic signs, trees, shrubs, neighboring vehicles, pedestrians, and so on.

The assistance system 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The assistance system 160 either independently or in combination with the pose system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 240. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The assistance system 160 can be configured to implement determined driving maneuvers. The assistance system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The assistance system 160 can be configured to execute various vehicle functions and/or to transmit data to, receive data from, interact with, and/or control the vehicle 100 or one or more systems thereof (e.g., one or more of vehicle systems 150).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A pose system, comprising:
one or more processors;
a memory communicably coupled to the one or more processors and storing instructions that, when executed by the one or more processors, cause the one or more processors to:
acquire target information and sensor data of a surrounding environment that includes a person, the target information defining a target space that includes a target pose and a target camera view;
extract appearance features of the person from the sensor data;
map the appearance features into the target space, including aggregating the appearance features into an aggregated feature map;
render the target camera view of the person in the target pose according to the aggregated feature map; and
provide the target camera view.

2. The pose system of claim 1, wherein the instructions to extract the appearance features include instructions to apply a fine model to extract fine features at a fine granularity and apply a coarse model to extract coarse features at a coarse granularity, and
wherein the instructions to extract the appearance features include instructions to refine the coarse features into refined features and combine the refined features with the fine features to generate the appearance features.

3. The pose system of claim 2, wherein the fine model and the coarse model are encoders, and wherein the instructions to refine the coarse features include instructions to apply a transformer model to generate the refined features.

4. The pose system of claim 1, wherein the instructions to extract the appearance features include instructions to lift the appearance features from a two-dimensional representation to a three-dimensional representation.

5. The pose system of claim 1, wherein the instructions to map the appearance features include instructions to transform source mesh vertices of the appearance features to the target space using the target pose and to populate a two-dimensional target feature map for pixels of the target camera view, and
wherein the instructions to aggregate the appearance features into the aggregated feature map include instructions to apply a multi-view transform to the two-dimensional target feature map that includes multiple ones of the appearance features per pixel of the target camera view to generate the aggregated feature map.

6. The pose system of claim 1, wherein the instructions to render the target camera view include instructions to apply an image rendering network that is conditioned on the target pose to the aggregated feature map.

7. The pose system of claim 1, wherein the instructions to provide the target camera view include instructions to perform one or more of communicate the target camera view to a path planner of a vehicle and simulate the target camera view according to a request to monitor the person, and
wherein the sensor data includes one or more of RGB monocular images and LiDAR data.

8. The pose system of claim 1, wherein the pose system is integrated with one of: a vehicle and a roadside unit (RSU).

9. A non-transitory computer-readable medium storing instructions that, when executed by one or more processors, cause the one or more processors to:
acquire target information and sensor data of a surrounding environment that includes a person, the target information defining a target space that includes a target pose and a target camera view;
extract appearance features of the person from the sensor data;
map the appearance features into the target space, including aggregating the appearance features into an aggregated feature map;
render the target camera view of the person in the target pose according to the aggregated feature map; and
provide the target camera view.

10. The non-transitory computer-readable medium of claim 9, wherein the instructions to extract the appearance features include instructions to apply a fine model to extract fine features at a fine granularity and apply a coarse model to extract coarse features at a coarse granularity, and
wherein the instructions to extract the appearance features include instructions to refine the coarse features into refined features and combine the refined features with the fine features to generate the appearance features.

11. The non-transitory computer-readable medium of claim 10, wherein the fine model and the coarse model are encoders, and wherein the instructions to refine the coarse features include instructions to apply a transformer model to generate the refined features.

12. The non-transitory computer-readable medium of claim 9, wherein the instructions to extract the appearance features include instructions to lift the appearance features from a two-dimensional representation to a three-dimensional representation.

13. The non-transitory computer-readable medium of claim 9, wherein the instructions to map the appearance features include instructions to transform source mesh vertices of the appearance features to the target space using the target pose and to populate a two-dimensional target feature map for pixels of the target camera view, and
wherein the instructions to aggregate the appearance features into the aggregated feature map include instructions to apply a multi-view transform to the two-dimensional target feature map that includes multiple ones of the appearance features per pixel of the target camera view to generate the aggregated feature map.

14. A method, comprising:
acquiring target information and sensor data of a surrounding environment that includes a person, the target information defining a target space that includes a target pose and a target camera view;
extracting appearance features of the person from the sensor data;
mapping the appearance features into the target space, including aggregating the appearance features into an aggregated feature map;
rendering the target camera view of the person in the target pose according to the aggregated feature map; and
providing the target camera view.

15. The method of claim 14, wherein extracting the appearance features includes applying a fine model to extract fine features at a fine granularity and applying a coarse model to extract coarse features at a coarse granularity, and wherein extracting the appearance features includes refining the coarse features into refined features and combining the refined features with the fine features to generate the appearance features.

16. The method of claim 15, wherein the fine model and the coarse model are encoders, and wherein refining the coarse features includes applying a transformer model to generate the refined features.

17. The method of claim 14, wherein extracting the appearance features includes lifting the appearance features from a two-dimensional representation to a three-dimensional representation.

18. The method of claim 14, wherein mapping the appearance features includes transforming source mesh vertices of the appearance features to the target space using the target pose and populating a two-dimensional target feature map for pixels of the target camera view, and
wherein aggregating the appearance features into the aggregated feature map includes applying a multi-view transform to the two-dimensional target feature map that includes multiple ones of the appearance features per pixel of the target camera view to generate the aggregated feature map.

19. The method of claim 14, wherein rendering the target camera view includes applying an image rendering network that is conditioned on the target pose to the aggregated feature map.

20. The method of claim 14, wherein providing the target camera view includes one or more of communicating the target camera view to a path planner of a vehicle and simulating the target camera view according to a request to monitor the person, and
wherein the sensor data includes one or more of RGB monocular images and LiDAR data.
